(19) United States
(12) Patent Application Publication
(10) Pub. No.: US 2024/0066740 A1
(43) Pub. Date: Feb. 29, 2024

(54) CONVEYING DEVICE COMPRISING A CLEANING DEVICE

(71) Applicants: Jürgen BIALY, Oeschebüttel (DE); PROVISUR TECHNOLOGIES, INC., Chicago, IL (US)

(72) Inventors: Jürgen BIALY, Oeschebüttel (DE); Klaus GUGGEMOS, Rettenberg (DE); Paul GOROLL, Waltenhofen (DE); Matthias HINDORFF, Waltenhofen (DE); Alexander MAY, Waltenhofen (DE); Florian MOHR, Sulzberg (DE); Klaus Dieter SCHROFF, Konstanz (DE)

(21) Appl. No.: 18/548,812

(22) PCT Filed: Feb. 17, 2022
(86) PCT No.: PCT/EP2022/053944

§ 371 Date: Sep. 1, 2023

(30) Foreign Application Priority Data
Mar. 3, 2021 (DE) 10 2021 105 103.7

(51) Int. Cl. B26D 7/32; B26D 7/30; B65G 45/24

(52) U.S. Cl. CPC B26D 7/32; B26D 7/30; B65G 45/24; B26D 2210/02

(57) ABSTRACT

The invention relates to a conveying device for conveying food products in a food processing installation, having at least one movable conveyed-product carrier (12, 13; 30, 31) for receiving the food products to be conveyed, and a drive system (15-18) for conveying the conveyed-product carrier (12, 13; 30, 31) discontinuously along a conveying path (27). The invention additionally provides a cleaning device (32) for cleaning the conveyed-products carrier (12, 13; 30, 31) and/or the conveying path (27).

The invention relates to a conveying device for conveying food products (e.g. stacks of slices of meat or cheese) in a food processing installation.

In industrial food processing, cutting devices (“slicers”) are known which slice food products (e.g. pieces of meat, cheese pieces, salami sticks) into slices and then deposit them in the form of stacks of slices on a conveyor belt which then conveys the stacks of slices further, for example to a packaging machine. Such conveyor belts belong to the group of continuous conveyors, as they can continuously convey the material to be conveyed.

It is also known from the state of the art to use so-called discontinuous conveyors for conveying the stacks of slices away from the cutting device, which have individual conveyed-products carriers (“shuttles”, “movers”) on which the slices can be deposited and which are then moved as a whole with the stacks of slices deposited on them along a fixed conveying path. This technology differs from the conventional technology described above in that it uses a discontinuous conveyor (conveyed-product carrier) instead of a continuous conveyor (conveyor belt). With this technology, however, there is the problem of contamination of the conveyed-products carrier and the conveying path.

Regarding the technical background of the invention, reference should also be made to DE 10 2014 106 400 A1, DE 10 2014 116 233 A1, US 2016/0 282 378 A1, DE 20 2020 102 692 U1 and DE 10 2017 131 304 A1.

The invention is therefore based on the task of creating a correspondingly improved conveying device.

First of all, the conveying device according to the invention has, in accordance with the known technology described above, a discontinuous conveyor with at least one movable conveyed-products carrier (“shuttle”, “mover”) for receiving the food products to be conveyed.

Furthermore, in accordance with the known technology described above, the conveying device according to the invention also has a drive system for moving the conveyed-products carrier along a conveying path. Such conveying devices are commercially available, for example, from the German company Beckhoff Automation GmbH under the product name “XPlanar”. However, the invention is not limited to the conveying device available under the product name “XPlanar” with respect to the technical realization of the drive system and the conveyor conveyed-products carrier.

The conveying system according to the invention is distinguished from the known technology described above by an additional cleaning device which is suitable for cleaning the conveyed-products carrier and/or the conveying path. In one variant of the invention, the cleaning device thus serves to clean the conveyed-products carrier, for which purpose the conveyed-products carrier can, for example, be moved into the cleaning device. In another variant of the invention, on the other hand, the cleaning device serves to clean the conveying path or the conveying surface. However, the two variants described above can also be combined within the scope of the invention, so that both the conveyor conveyed-products carrier and the conveying path are cleaned.

In a preferred embodiment of the invention, the cleaning device comprises a stationary cleaning station, wherein the conveying path leads into the cleaning station so that the conveyed-products carrier to be cleaned is moved into the cleaning station for cleaning. For example, the cleaning station may comprise an enclosed cleaning cabin in which the conveyed-products carriers are cleaned.

In one variant of this preferred embodiment of the invention, the cleaning station has an inlet and an outlet, wherein the conveying path leads into the cleaning station through the inlet, while the conveying path then leads out of the cleaning station again through the outlet, so that the conveyed-products carrier to be cleaned can be moved along the conveying path through the cleaning station without a reversal of direction.

In another variant of this preferred embodiment of the invention, on the other hand, the cleaning station has only one inlet, so that the conveyed-products carrier to be cleaned can be moved into the cleaning station through the inlet and, after a reversal of direction, is then moved out of the cleaning station again through the inlet.

However, the cleaning device is not limited to a stationary cleaning station with regard to its technical realization. Instead or in addition thereto, the cleaning device may comprise a movable cleaning carriage which can be moved along the conveying path by the drive system, thereby cleaning the conveying path. The movement of the cleaning carriage along the conveying path can be performed in the same way as the movement of the individual conveyed-products carriers along the conveying path.

It has already been briefly mentioned above with respect to the prior art that the conveying device can move the individual conveyed-products carriers along a fixed predetermined conveying path, i.e. virtually rail-bound. In one variant of the invention, this is also the case with the conveying device according to the invention. In another variant of the invention, however, the conveying path is freely programmable within a conveying surface, as is also the case, for example, with the “XPlanar” conveying system from the German company Beckhoff Automation GmbH.

With regard to the cleaning principle of the cleaning device, a variety of possibilities exist within the scope of the invention, some of which are briefly described below.

For example, the cleaning device can have a spraying device which sprays the conveyed-products carrier and/or the conveying path with a cleaning fluid during a cleaning process.

It is also possible for the cleaning device to have a brush device for brushing the conveyed-products carrier and/or the conveying path.

Furthermore, the cleaning device can have a blowing device for blowing off contamination from the conveyed-products carrier and/or the conveying path with compressed air.

Furthermore, a disinfection device may be provided to disinfect the conveyed-products carrier, the conveying path and/or the conveying surface.

A scraping device may also be provided to scrape off adhering contaminants.

In addition, it may be advantageous to provide a disinfection device for killing germs, which operates, for example, by irradiation with UV light.

Furthermore, the cleaning device can have a cleaning bath into which the conveyed-products carriers are immersed for cleaning.

Subsequently, the cleaned conveyed-products carriers can then be dried again in a drying device.

The above-mentioned examples of technical designs of the cleaning device can also be implemented in any combination with each other.

It has already been mentioned above that the drive system for the movement of the individual conveyed-products carriers or the cleaning carriage can be realized, for example, according to the conveying device available under the product name “XPlanar” from the German company Beckhoff Automation GmbH. In this case, the drive system operates contactlessly without any contact between the conveyed-products carrier on the one hand and the conveying path on the other. Furthermore, it should be mentioned that the contactless drive system is preferably a magnetic levitation system.

In the preferred embodiment of the invention, the contactless drive system has several modules which are adjacent to each other and form a continuous conveying surface, whereby the conveying path within the conveying surface is freely programmable. Preferably, the individual modules are each rectangular so that they can be assembled to form the conveying surface with almost no gaps.

Such a modular system is also the above-mentioned known conveying device “XPlanar”, which is therefore suitable within the scope of the invention.

Furthermore, it should be mentioned that the invention does not only claim protection for the above described conveying device. Rather, the invention also claims protection for a complete food processing installation comprising such a conveying device and a plurality of processing stations for processing the food products, wherein the conveying device can transport the food products between the various processing stations.

With regard to the technical realization of the individual processing stations, a variety of possibilities exist within the scope of the invention, some of which are briefly described below.

For example, one of the processing stations can be a cutting device which serves to cut the food products into slices. Such cutting devices are known per se from the prior art and are also referred to as “slicers”.

Another example of a processing station is a scale for weighing the food products or the slices of the food products. Preferably, the scale then weighs in the individual food product carrier with the food products thereon.

Furthermore, one of the processing stations may be a packaging machine used for packaging the slices. For example, this packaging machine can be a thermoformer or a flow packer.

Another example of a processing station is a product scanner for scanning the shape of the food products. Such product scanners are known per se from the prior art and therefore need not be described in detail. For example, such product scanners can scan the product shape according to the light section method.

Furthermore, there is also the possibility that one of the processing stations is a pressing device which presses the food products, as is known, for example, from the German patent application DE 10 2019 110 313 A1, so that the content of this earlier patent application is fully attributable to the present description with regard to the construction and operation of the pressing device.

Further, it should be noted that the invention does not claim protection only for the conveying device described above and the food processing installation also described above. Rather, the invention also claims protection for a corresponding operating method.

Within the scope of the operating method according to the invention, it is first provided, in accordance with the prior art, that a conveyed-products carrier is loaded with a food product. This may be, for example, a stack of slices comprising a plurality of slices of meat or cheese.

Further, the method of operation according to the invention provides that the loaded conveyed-products carrier is moved along a conveying path between different processing stations of the food processing installation, for example from a cutting device to a packaging machine.

Furthermore, the operating method according to the invention provides that the conveyor conveyed-products carrier is then unloaded in order to be able to pack the stack of slices, for example in a packaging machine. For this purpose, a take-off conveyor is preferably used, such as is known, for example, from the German patent application DE 10 2020 105 678, so that the contents of this earlier patent application are to be fully attributed to the present description with regard to the design and mode of operation of the take-off conveyor and of the carrier of conveyed material. At this point, it is only necessary to briefly mention that the conveyed-products carrier preferably has elongated recesses on its upper side, into which the take-off conveyor can then plunge with its parallel knife conveyor belts in order to engage underneath and convey away the stack of sheets on the conveyed-products carrier.

The operating method according to the invention additionally provides for cleaning of the conveyed-products carrier and/or the conveying path or surface. For this purpose, the conveyed-products carrier is preferably unloaded and then moved in the unloaded state to a cleaning station where the conveyed-products carrier is cleaned, as already described above with respect to the conveying device.

Furthermore, for cleaning the conveying path and/or the conveying surface, a cleaning carriage can be moved along the conveying path, as has been described above also with respect to the conveying device.

Other advantageous further embodiments of the invention are indicated in the dependent claims or are explained in more detail below together with the description of the preferred embodiments of the invention with reference to the figures.

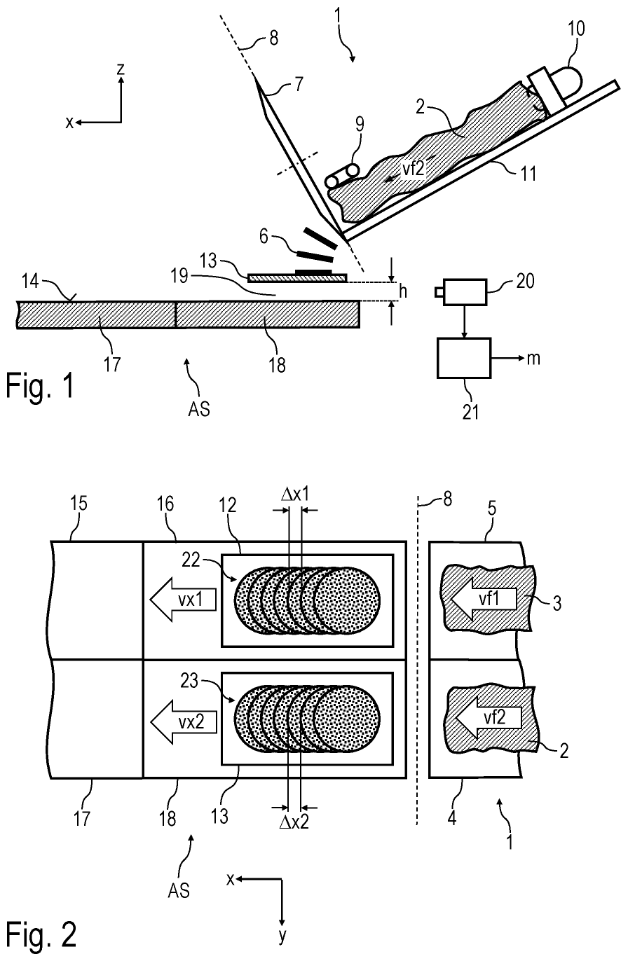

FIG. 1 shows a schematic side view of a food processing installation according to the invention.

FIG. 2 shows a schematic top view of the food processing installation from FIG. 1.

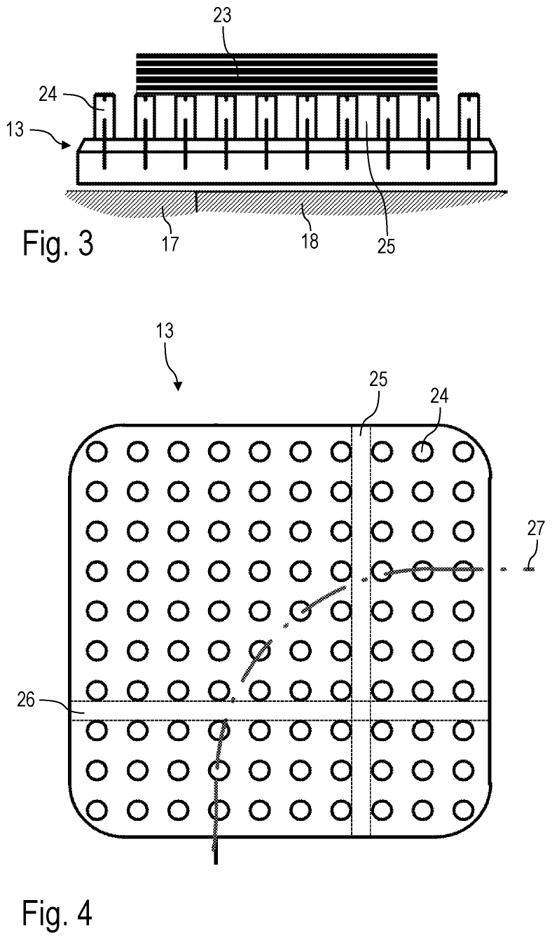

FIG. 3 shows a side view of a single conveyed-products carrier of the food processing installation of FIGS. 1 and 2.

FIG. 4 shows a top view of the conveyed-products carrier according to FIG. 3.

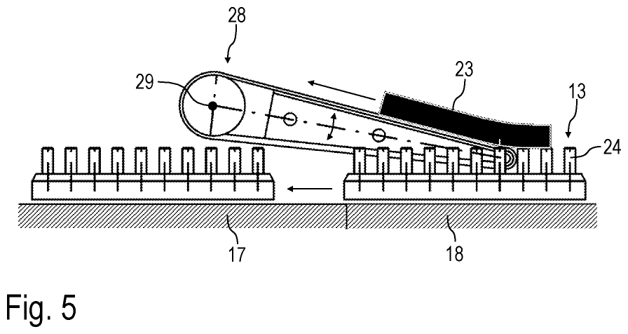

FIG. 5 shows a schematic side view of a take-off conveyor for removing the food products from the goods carrier.

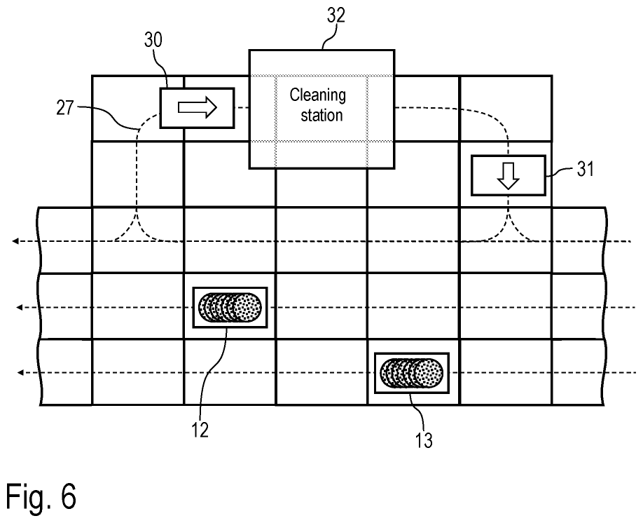

FIG. 6 shows a schematic view of the food processing installation according to the invention with a cleaning station for cleaning the individual conveyed-products carriers.

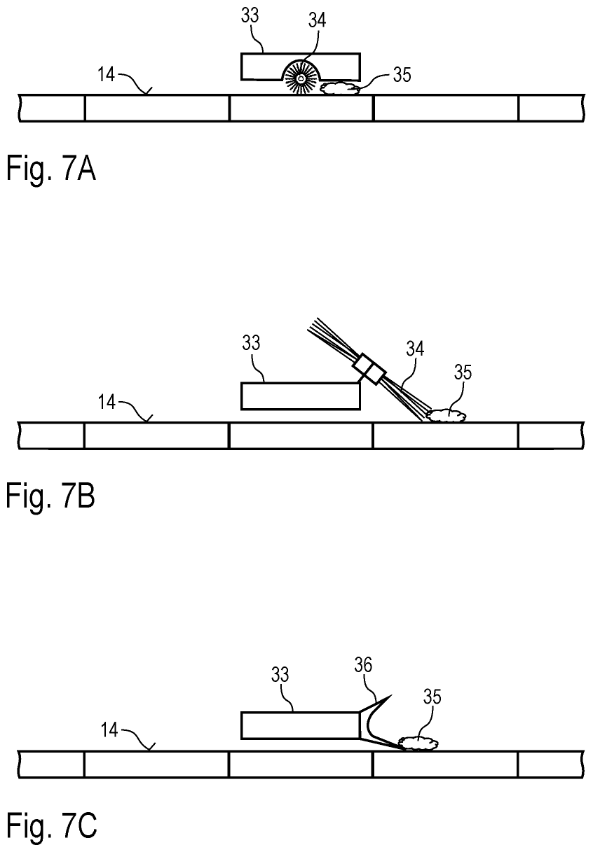

FIG. 7A shows a schematic side view of a cleaning carriage with a cleaning brush for cleaning the conveying surface.

FIG. 7B shows a variation of FIG. 7A with a different orientation of the cleaning brush.

FIG. 7C shows a cleaning carriage with a scraper for scraping off dirt deposits on the conveying path.

In the following, the embodiment according to FIGS. 1-5 will now be described.

First of all, the food processing installation in this embodiment has a cutting device 1, which can be of largely conventional design and cuts food products 2, 3 into slices 6 in two parallel conveyor tracks 4, 5.

For this purpose, the cutting device 1 comprises a cutting blade 7 which rotates in a cutting plane 8 during operation and is driven by an electric motor which is not shown.

In addition, the cutting device 1 has a feeding device which moves the food products 2, 3 into the cutting plane 8 with a specific feed speed vf1, vf2. For this purpose, the feeding device can have a conveyor belt 9 that grips the food products 2 or 3 at the top and conveys them into the cutting plane 8. In addition, the feeding device can also have a gripper 10 which grips the food products 2, 3 at their rear side and pushes them into the cutting plane 8. In the side view in FIG. 1, only the conveyor belt 9 and the gripper 10 for the food product 2 are shown. On the opposite side, however, there is also an unidentified conveyor belt for the other food product 3 and likewise an associated gripper for the food product 3. The food products 2, 3 are here conveyed on an inclined product support 11 into the cutting plane 8, as is known per se from the prior art. However, the design of the feeding device described above is only exemplary, since other designs of the feeding device are also possible within the scope of the invention.

Furthermore, in this embodiment, the food processing installation comprises a plurality of conveyed-products carriers 12, 13 which can be moved parallel to a horizontal conveying surface 14 by a contactless drive system AS. The contactless drive system AS is here composed of several rectangular modules 15-18, which are assembled without gaps and form the continuous conveying surface 14. For simplification, only the four modules 15-18 are shown. In practice, however, the conveying surface 14 is composed of a larger number of modules. The contactless drive system AS operates here according to the magnetic levitation technique as known from the commercially available system “XPlanar” mentioned at the beginning. FIG. 1 shows that the conveyed-products carrier 13 is held in suspension above the conveying surface 14, so that a gap 19 is formed between the conveyed-products carrier 13 and the conveying surface 14. The height h of the gap 19 is detected by a camera 20 and reported to a control device 21, which uses it to determine the total mass m of the conveyed-products carrier 13 with the conveyed material on it. One possibility for this is that the drive power of the contactless drive system AS is controlled in such a way that the height h of the gap 19 remains constant regardless of the total weight m of the conveyed-products carrier 13. The drive power required for this then forms a measure of the total mass m of the conveyed-products carrier 13.

During a cutting process, the conveyed-products carriers 12, 13 are arranged below the cutting device in the line of fall of the slices 6, so that the slices 6 fall onto the conveyed-products carrier 13 or 14 and form stacks of slices 22, 23 there.

FIG. 2 shows that the stack of slices 22, 23 are shingled. This means that the superimposed slices have a certain offset Δx1 or Δx2 to each other. In order to realize these shingled stacks of slices 22, 23, the conveyed-products carriers 12, 13 are moved by the corresponding offset Δx1 or Δx2 after each of the slices 6 has been deposited, so that the desired slice offset is achieved.

However, it is also possible within the scope of the invention for other portion shapes to be produced. It should be mentioned here that the different portion shapes can be realized without hardware adaptations by a software modification alone. This distinguishes the food processing installation according to the invention from conventional food processing installations, in which a change of the portion shape is only possible with mechanical changes.

In the following, the conveyed-products carrier 13 will now be described in more detail, with reference to FIGS. 3 and 4. In principle, the construction and the mode of operation of the conveyed-products carrier are known from the earlier patent application DE 10 2020 105 678.8, so that the contents of that patent application can be fully attributed to the present description with respect to the construction of the conveyed-products carrier 13. Furthermore, it should be mentioned that the other conveyed goods carriers can be constructed in the same way.

On the upper side of the conveyor conveyed-products carrier 13 there are numerous pins 24, each of which has a cylindrical cross-section and projects vertically upwards. The pins 24 are arranged here in a matrix-like manner in rows and columns, two columns of the pins 24 each enclosing a recess 25, just as two rows of the pins 24 enclose a recess 26.

FIG. 4 shows by way of example that the conveyed-products carrier 13 can be moved along a curved conveying path 27, the course of the conveying path 27 shown being only exemplary.

The recesses 25, 26 serve to remove the stack of slices 23 from the conveyed-products carrier 13, as can be seen in FIG. 5. For this purpose, a pivotable take-off conveyor 28 is provided, which can be pivoted about a pivot axis 29 in the direction of the double arrow. The take-off conveyor 28 consists of several parallel narrow knife conveyors (finger conveyors), which can each dip into the recesses 25 or 26 between the pins 24 of the conveyed-products carrier 13 in order to then convey away the stack of slices 23. The construction and the mode of operation of the take-off conveyor 28 are also described in the earlier patent application DE 10 2020 105 678.8, so that the contents of this earlier patent application are to be fully attributed to the present description with regard to the construction and the mode of operation of the take-off conveyor 28.

In the following, the special features of the depicted food processing installation according to the invention will now be described, with reference to FIG. 6. Thus FIG. 6 shows the conveying surface 14 with the two conveyed-products carriers 12, 13, which are shown here in a loaded condition, i.e. the two conveyed-products carriers 12, 13 are each loaded with a shingled stack of slices 22 and 23 respectively.

In addition, two empty product carriers 30, 31 are shown, whereby the product carrier 30 is moved to a cleaning station 32 for cleaning, while the product carrier 31 has already been cleaned in the cleaning station 32. In the cleaning station 32, the conveyed-products carrier 30 to be cleaned can, for example, be sprayed with a cleaning liquid and brushed off. Subsequently, the conveyed-products carrier 30 can then be blown off with compressed air to remove dirt residues. Furthermore, the cleaning station 32 may comprise a sterilization device to sterilize the conveyed-products carrier 30, for example by irradiation with UV light. However, the design and operation of the cleaning station 32 is not limited to the cleaning principles described above with respect to the cleaning principle.

Furthermore, it should be mentioned that the conveying path 27 is freely programmable here and, in the example shown, passes through the cleaning station 32. The conveyed-products carrier 30 to be cleaned can therefore be moved along the conveying path 27 through the cleaning station 32.

In the embodiment example according to FIG. 6, the cleaning device comprises the stationary cleaning station 32. However, it is additionally or alternatively also possible that a cleaning carriage 33 is used, as it is schematically shown in FIG. 7A. In this case, the cleaning carriage 33 can be moved freely by the drive system within the conveying surface 14 in the same way as the individual conveyed-products carriers 12, 13, 30, 31 in order to clean the conveying surface 14. For this purpose, the cleaning carriage 33 has on its underside a cleaning brush 34 which rotates during operation and can brush off dirt residues 35 from the conveying surface 14. It should be mentioned here that the cleaning carriage 33 is not necessarily driven by the drive system AS which also drives the individual conveyed-products carriers 12, 13. Alternatively, it is also possible that the cleaning carriage 33 has its own drive or is driven in some other way.

FIG. 7B shows a modification of FIG. 7A, so that in order to avoid repetition, reference is first made to the above description of FIG. 7A, the same reference signs being used for corresponding details.

A special feature of this embodiment is the orientation of the cleaning brush 34. Thus, the axis of rotation of the cleaning brush 34 is oriented horizontally in the embodiment according to FIG. 7A, whereas the axis of rotation of the cleaning brush 34 is oriented obliquely in the embodiment according to FIG. 7B.

FIG. 7C shows a further modification of the cleaning carriage 33, so that to avoid repetition reference is again made to the above description of FIGS. 7A and 7B.

A special feature of this embodiment is that instead of the cleaning brush 34, a scraper 36 is provided which can scrape off the dirt residues 35 from the conveying surface 14.

The invention is not limited to the preferred embodiments described above. Rather, a large number of variants and variations are possible which also make use of the idea of the invention and therefore fall within the scope of protection. In particular, the invention also claims protection for the subject matter and the features of the dependent claims independently of the claims referred to in each case and in particular also without the features of the main claim. The invention thus comprises different aspects of the invention which enjoy protection independently of each other.

### LIST OF REFERENCE SIGNS

1 Cutting device
2, 3 Food products
4, 5 Conveyor tracks of the cutting device
6 Slices
7 Cutting knife
8 Cutting plane
9 Conveyor belt of the feeding device of the cutting device
10 Gripper of the feeding device of the cutting device
11 Product support
12, 13 Product carrier
14 Conveying surface
15-18 Modules of the drive system
19 Gap between conveying surface and product carrier
20 Camera
21 Control device
22, 23 Shingled stack of slices
24 Pins on the top of the conveyed-products carrier
25, 26 Recesses between the pins
27 Conveying path
28 Take-off conveyor for taking off the food products from the product carrier
29 Pivot axis of the take-off conveyor
30 Conveyor belt before cleaning
31 Conveyor belt after cleaning
32 Cleaning station
33 Cleaning carriage
34 Cleaning brush
35 Dirt residue
36 Scraper
AS Drive system for driving the conveyed-products carriers
vf1, vf2 Feed speed in the conveyor tracks of the cutting device
vx1, vx2 Feeding speed on the conveying surface
Δx1, Δx1 Offset when slices are deposited

1. A conveying device for conveying food products in a food processing installation, in particular for conveying stacks of slices of meat pieces or cheese pieces, comprising:
at least one movable conveyed-products carrier for receiving the food products to be conveyed;
a drive system for discontinuously conveying the conveyed-products carrier along a conveying path; and
a cleaning device for cleaning the conveyed-products carrier and/or the conveying path.

2. The conveying device according to claim 1, characterized in that the cleaning device comprises a stationary cleaning station and the conveying path leads into the cleaning station, so that the conveyed-products carrier to be cleaned is moved into the cleaning station for cleaning.

3. The conveying device according to claim 1,
wherein the cleaning station comprises an inlet and an outlet, and the conveying path leads through the inlet into the cleaning station and out of the outlet out of the cleaning station again, so that the conveyed-products carrier to be cleaned can be moved along the conveying path through the cleaning station without a reversal of direction, or
wherein the cleaning station comprises only one inlet, so that the conveyed-products carrier to be cleaned can be moved into the cleaning station through the inlet and, after a reversal of direction, can be moved out of the cleaning station through the inlet again.

4. The conveying device according to claim 1, wherein the cleaning device comprises a movable cleaning carriage which can be moved along the conveying path by the drive system and thereby cleans the conveying path.

5. The conveying device according to claim 1, wherein the conveying path is freely programmable within a conveying surface.

6. The conveying device according to claim 1, wherein the cleaning device for cleaning the conveyed-products carrier comprises the following:
a spraying device for spraying the conveyed-products carrier or the conveying path with a cleaning liquid, and/or
a brushing device for brushing the conveyed-products carrier or the conveying path, and/or
a blowing device for blowing off contamination on the conveyed-products carrier or on the conveying path, and/or
a disinfection device for disinfecting the conveyor and/or the conveying path and/or the conveying surface, and/or
scraping means for scraping off contamination from the conveyed-products carrier or from the conveying path, and/or
a disinfection device for killing germs on the conveyor and/or the conveying path and/or the conveying surface, in particular by irradiation with UV light, and/or
a cleaning bath for immersing and cleaning the conveyed-products carrier, and/or
a drying device for drying the conveyed-products carrier after cleaning in the cleaning bath.

7. The conveying device according to claim 1, wherein the drive system operates without contact between the conveyed-products carrier on the one hand and the conveying path on the other hand.

8. The conveying device according to claim 7, wherein the contactless drive system comprises a magnetic levitation system.

9. The conveying device according to claim 7, wherein the contactless drive system comprises a plurality of modules which adjoin one another and form a continuous conveying surface, the conveying path being freely programmable within the conveying surface.

10. The conveying device according to claim 9,
wherein the individual modules are each rectangular in order to be assembled to form the conveying surface, and
that wherein the modules are optionally assembled without gaps or at a distance from each other to the conveying surface.

11. A food processing installation for processing food products, in particular meat pieces or cheese pieces, comprising:
a plurality of processing stations for processing the food products, and
a conveying device according to any one of the preceding claims for moving the conveyed-products carrier with the food products thereon between the processing stations of the food processing installation.

12. The food processing installation according to claim 11, further comprising:
a cutting device for cutting the food products into slices, and/or
a scale for weighing the food products or the slices of the food products, and/or
a packaging machine for packaging the slices of the food products, in particular as a thermoforming machine or flow packer, and/or
a product scanner for scanning the shape of the food products, and/or
a pressing device for pressing the food products.

13. An operating method for a food processing installation according to claim 11, comprising:
loading the food product carrier with a food product, in particular with a single slice or with a stack of slices, in particular with a shingled stack of slices cut from a piece of meat or a piece of cheese,
moving the loaded conveyed-products carrier along the conveying path between at least two processing stations of the food processing installation, in particular from a cutting device to a packaging machine, and
unloading the conveyed-products carrier, in particular by means of a take-off conveyor which dips into elongated recesses in the conveyed-products carrier and engages under the food product, and
cleaning the conveyed-products carrier and/or the conveying path.

14. The operating method according to claim 13, wherein the conveyed-products carrier is unloaded for cleaning and, in the unloaded state, is moved to a cleaning station where the conveyed-products carrier is cleaned.

15. The operating method according to claim 13,
wherein for cleaning the conveying path and/or the conveying surface a cleaning carriage is moved along the conveying path, and
wherein the cleaning carriage is optionally driven by the drive system.
